(19) United States
(12) Patent Application Publication
(10) Pub. No.: US 2007/0022236 A1
(43) Pub. Date: Jan. 25, 2007

(54) Computer keyboard integrated with internet phone service

(76) Inventors: Ing-Kai Huang, Hsinchu City (TW); Douglas Wang, Hsinchu City (TW)

Correspondence Address: HDSL, 4331 STEVENS BATTLE LANE, FAIRFAX, VA, 22033, US

(21) Appl. No.: 11/187,899

(22) Filed: Jul. 25, 2005

(51) Int. Cl. G06F 13/38

(52) U.S. Cl. 710/69

(57) ABSTRACT

A computer keyboard integrated with Internet phone service includes a keyboard controller, a USB hub and an audio controller. The keyboard controller receives an input command from the keyboard. The USB hub relays the signal of the keyboard controller to the computer, and relays the digital signal of the computer to the audio controller, and relays the digital signal of the audio controller to the computer. Moreover, the audio controller receives the digital signal from the USB hub and converts the analog signal to analog signal. The audio controller receives the analog signal from a conversation unit and converts the analog signal to digital signal for sending to the USB hub and then sending to the computer. Therefore, user can performs Internet conversation through Internet with remote host and telephone set.

### BACKGROUND OF THE INVENTION

1. Field of the Invention

The present invention relates to a computer keyboard, more particularly to a computer keyboard integrated with Internet phone service through a Universal Serial Bus (USB) connection line.

2. Description of Related Art

The fast development of network has changed the industry facet of other area. For example, some of the telecommunication service has been replaced with Internet phone services such as Skype, MSN, AOL, Peer-Call etc.

However, the computer user generally needs earphone and microphones to access Internet phone with remote party. It is inconvenient for user with computer host below his desk or the user not familiar with computer architecture.

FIGS. 1 and 2 show a keyboard with an audio input socket and an audio output socket. This keyboard with audio input/output socket comprises a keyboard main body 1 with a digital connection line 11 connected with a USB port, which is compatible with a computer USB port interface.

The keyboard main body 1 comprises two audio sockets 2a and 2b on left side thereof and used for the connection of earphone (or loud speaker) and microphone. The audio sockets 2a and 2b are connected to the audio output end 31 and audio input end 32 of the computer through a signal line 21, therefore the audio interface of the computer 3 is extended to the keyboard main body 1. When user needs to access audio service from the computer, he only needs to connect the audio plug of the earphone, loudspeaker or microphone to the audio sockets 2a and 2b on the keyboard main body 1.

However, in above-mentioned keyboard, there are two additional signal lines 21 provided for audio signal input and output. This might cause confuse for novice user because they will find difficult to correctly connect the signal lines 21 to the computer 3.

### SUMMARY OF THE INVENTION

The present invention is intended to provide a computer keyboard integrated with Internet phone service through a USB connection line, whereby user can talk with remote host or telephone set through Internet without audio line connected to keyboard.

Accordingly, the present invention provides a computer keyboard integrated with Internet phone service comprising a keyboard controller, a USB hub and an audio controller. The keyboard controller receives an input command from the keyboard. The USB hub relays the signal of the keyboard controller to the computer, and relays the digital signal of the computer to the audio controller, and relays the digital signal of the audio controller to the computer. Moreover, the audio controller receives the digital signal from the USB hub and converts the analog signal to analog signal. The audio controller receives the analog signal from a conversation unit and converts the analog signal to digital signal for sending to the USB hub and then sending to the computer. Therefore, user can performs Internet conversation through Internet with remote host and telephone set.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a conventional keyboard with an audio input socket and an audio output socket.

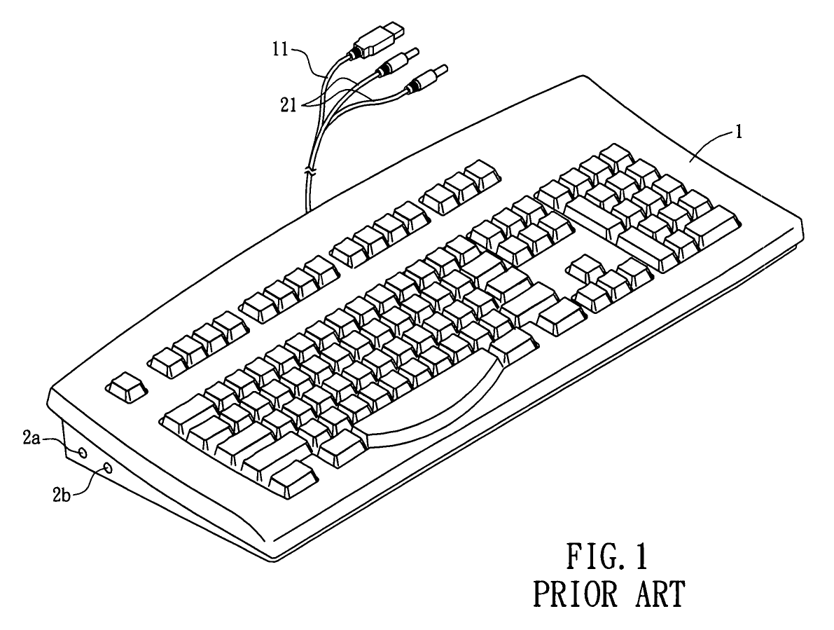

FIG. 2 shows the conventional keyboard of FIG. 1 connected with a computer.

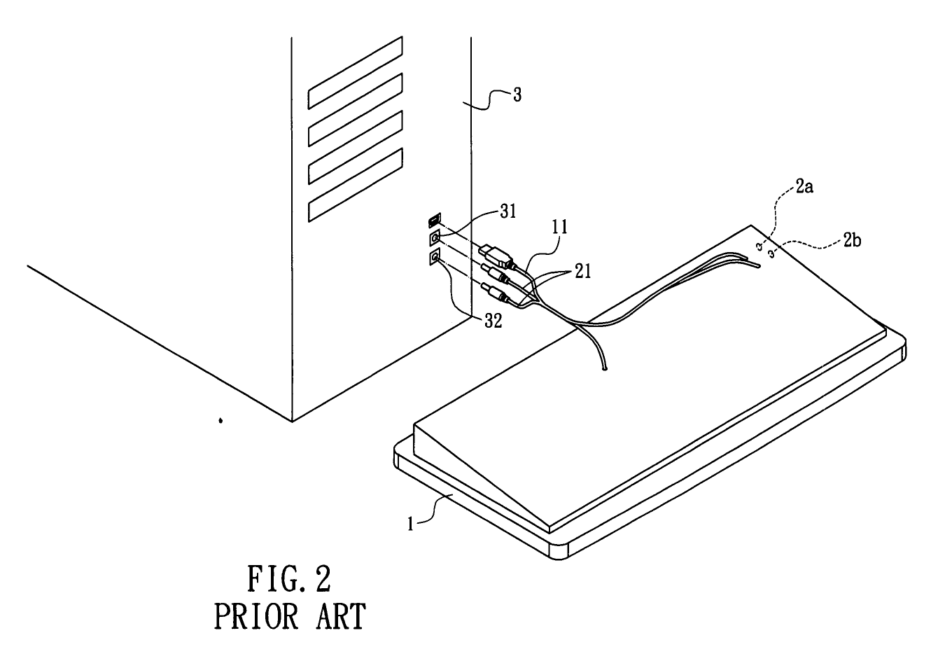

FIG. 3 shows a computer keyboard integrated with Internet phone service according to a preferred embodiment of the present invention.

FIG. 4 shows the block diagram of the computer keyboard integrated with Internet phone service according to a preferred embodiment of the present invention.

### DETAILED DESCRIPTION OF THE INVENTION

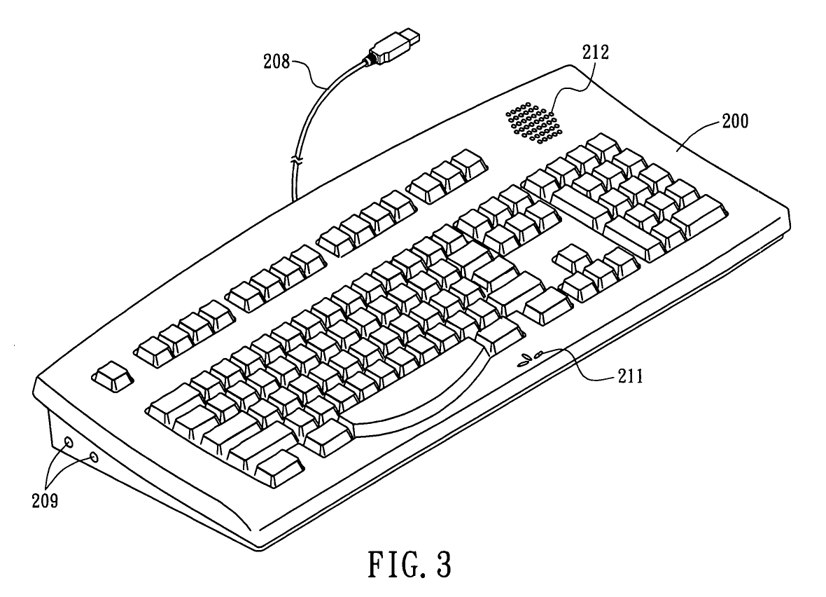

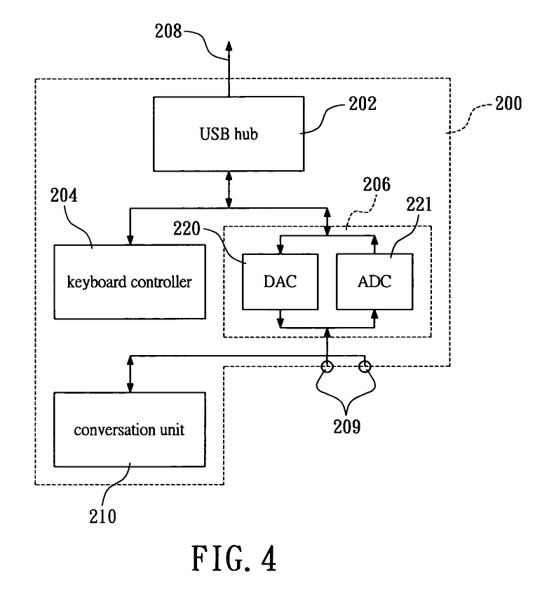

FIGS. 3 and 4 show the keyboard integrated with Internet phone according to a preferred embodiment of the present invention. The keyboard 200 comprises a USB hub 202, a keyboard controller 204 and an audio controller 206 and a conversation unit 210 built in the keyboard 200.

The keyboard controller 204 is used to receive an input command sent from a key stroke of the keyboard. The input command is processed by the keyboard controller 204 and then sent to the computer through the USB hub 202.

The USB hub 202 is electrically connected to the keyboard controller 204 and the audio controller 206, and is connected to the compute through the USB connection line 208. The USB hub 202 receives the input command from the keyboard controller 204 and then sends the input command to the computer through the USB connection line 208.

The USB hub 202 also receives data sent from the computer. When user uses Internet phone, the USB hub 202 receives a digital output signal of the computer from the USB connection line 208 and then sends the digital output signal to the audio controller 206, wherein the digital output signal is an audio digital signal of conversation received by the computer through the Internet.

The audio controller 206 is electrically connected to the USB hub 202 and the audio controller 206 comprises a DAC (digital to analog converter) 220 and an ADC (digital to analog converter) 221. The DAC 220 converts a digital signal of the USB hub 202 to an analog signal and the ADC 221 converts an analog signal of the audio controller 206 to a digital signal.

According to a preferred embodiment of the present invention, the audio controller 206 comprises a built in conversation unit 210 in the keyboard and the conversation unit 210 is one of a microphone 211 and a speaker 212 for receiving an analog signal. The keyboard further comprises at least one expansion interface 209, whereby the audio controller 206 can be connected to one of an earphone, a telephone handset and a legacy phone.

The conversation unit 210 is functioned to receive and transmit an analog signal and send the analog signal to the audio controller 206. The audio controller 206 uses the ADC 221 to convert the analog signal to a digital signal. The digital signal is then sent to the computer through the USB hub 202 and the USB connection line 208. Afterward, the computer sends the digital signal to remote computer and remote telephone set through Internet network. The digital signal received by the computer is sent to the USB hub 202 through the USB connection line 208 and then sent to the DAC 220 of the audio controller 206 through the USB hub 202 for processing therein. The processed analog signal is sent to the conversation unit 210.

To sum up, the keyboard integrated with Internet phone service can achieve the command, digital audio I/O signal transmission between keyboard and computer through a USB line. The cost is reduced and the user only needs to plug a USB connection line to the USB interface of the computer instead of finding the input/output socket of audio card.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A computer keyboard integrated with Internet phone service and connected to a computer through a Universal Serial Bus (USB) connection line, the computer keyboard comprising:
a keyboard controller receiving an input command from the keyboard;
a USB hub electrically connected to the computer and the keyboard controller and used to receive and transmit the input command, the USB hub further receiving a digital input signal and a digital output signal;
a conversation unit used to receive and transmit an analog signal;
an audio controller electrically connected to the USB hub and converting a digital signal to an analog signal for outputting the analog signal, the audio controller receiving the analog signal output from the conversation unit and converting the analog signal to a digital signal for inputting to the USB hub.

2. The computer keyboard as in claim 1, wherein the conversation unit is a microphone or a loudspeaker.

3. The computer keyboard as in claim 1, wherein at least one expansion interface is built in for connecting to the audio controller.

4. The computer keyboard as in claim 3, wherein the expansion interface s connected to one of an earphone, a telephone handset and a legacy phone.

5. The computer keyboard as in claim 1, wherein the audio controller comprises a DAC (digital to analog converter) and an ADC (digital to analog converter).

6. A computer keyboard integrated with Internet phone service and connected to a computer through a Universal Serial Bus (USB) connection line, the computer keyboard comprising:
a USB hub electrically connected to the computer and receiving a digital input signal and a digital output signal;
a conversation unit used to receive and transmit an analog signal;
an audio controller electrically connected to the USB hub and converting a digital signal to an analog signal for outputting the analog signal, the audio controller receiving the analog signal output from the conversation unit and converting the analog signal to a digital signal for inputting to the USB hub.

7. The computer keyboard as in claim 6, wherein the USB hub is electrically connected to a keyboard controller for receiving the digital input signal and the digital output signal;

8. A computer keyboard integrated with Internet phone service and connected to a computer through a Universal Serial Bus (USB) connection line, the computer keyboard comprising:
a keyboard controller receiving an input command from the keyboard;
a USB hub electrically connected to the computer and the keyboard controller and used to receive and transmit the input command, the USB hub further receiving a digital input signal and a digital output signal;
an audio controller electrically connected to the USB hub and converting a digital signal to an analog signal for outputting the analog signal, the audio controller receiving an analog signal output and converting the analog signal to a digital signal for inputting to the USB hub.
